(19) United States
(12) Patent Application Publication
(10) Pub. No.: US 2025/0053812 A1
(43) Pub. Date: Feb. 13, 2025

(54) WIRELESS BASE STATION, METHOD FOR CONTROLLING WIRELESS BASE STATION, COMMUNICATION CONTROL DEVICE, METHOD FOR CONTROLLING COMMUNICATION CONTROL DEVICE, AND PROGRAM

(71) Applicant: SONY GROUP CORPORATION, TOKYO (JP)

(72) Inventors: HIROMASA UCHIYAMA, TOKYO (JP); SHINICHIRO TSUDA, TOKYO (JP)

(21) Appl. No.: 18/722,568

(22) PCT Filed: Dec. 1, 2022
(86) PCT No.: PCT/JP2022/044311

§ 371 Date: Jun. 20, 2024

(30) Foreign Application Priority Data
Dec. 28, 2021 (JP) 2021-215210

(51) Int. Cl. G06N 3/082

(52) U.S. Cl. CPC G06N 3/082

(57) ABSTRACT

An object is to improve network delay. A wireless base station according to an embodiment of the present disclosure is a wireless base station capable of communicating with a first communication device and a second communication device, and includes: a splitting unit configured to acquire first profile information corresponding to one or more neural network models, and determine a splitting point for split of multiple layers constituting the neural network model on the basis of the first profile information; and a control unit configured to set, in the first communication device, arithmetic processing of a first neural network model generated by splitting the neural network model at the splitting point, and set, in the second communication device or the wireless base station, arithmetic processing of a second neural network model generated by splitting the neural network model at the splitting point.

### TECHNICAL FIELD

The present disclosure relates to a wireless base station, a method for controlling a wireless base station, a communication control device, a method for controlling a communication control device, and a program.

### BACKGROUND ART

The fifth generation mobile communication system (5GS) has characteristics of high speed and high capacity (enhanced mobile broadband: eMBB), low latency and high reliability (ultra-reliable and low latency communications: URLLC), and massive simultaneous connections (massive machine type communication: mMTC).

In the 5GS, utilization of artificial intelligence (AI) is expected for effective utilization of network resources and efficient and power-saving operation of the network.

In utilization of artificial intelligence (AI), inference using a machine learning model, particularly a deep learning model, and training of the model are expected, and it is desirable to achieve optimal utilization by acquiring necessary data from a terminal and a network device, and taking into account a configuration of the network and wireless communication quality.

### CITATION LIST

### Non-Patent Document

Non-Patent Document 1: 3rd generation partnership project (3GPP), “Technical report (TR) 22.874, V 0.1.0, Study on traffic characteristics and performance requirements for AI/ML model transfer” (Chapter 5 Split AI/ML operation between AI/ML endpoints)<URL: https://portal.3gpp.org/desktopmodules/Specifications/Specificat ionDetails.aspx?specificationId=3721>

### SUMMARY OF THE INVENTION

### Problems to be Solved by the Invention

The present disclosure has been made in view of the above-described problem, and an object of the present disclosure is to improve network delay.

### Solutions to Problems

A wireless base station according to an embodiment of the present disclosure is a wireless base station capable of communicating with a first communication device and a second communication device, and includes: a splitting unit configured to acquire first profile information corresponding to one or more neural network models, and determine a splitting point for split of multiple layers constituting the neural network model on the basis of the first profile information; and a control unit configured to set, in the first communication device, arithmetic processing of a first neural network model generated by splitting the neural network model at the splitting point, and set, in the second communication device or the wireless base station, arithmetic processing of a second neural network model generated by splitting the neural network model at the splitting point.

### BRIEF DESCRIPTION OF DRAWINGS

FIG. 1 is a block diagram illustrating a configuration of a network architecture of a 5G system (5GS) 1000.

FIG. 2 is a diagram illustrating an example of a QoS architecture.

FIG. 3 is a diagram illustrating an example of a configuration of a 5G network architecture including integrated access and backhaul (IAB).

FIG. 4 is a diagram illustrating an example of a configuration of a deep neural network model used in deep learning.

FIG. 5 is a diagram illustrating an example of connection processing of the 5G system.

FIG. 6 is a diagram illustrating an example of PDU session establishment processing.

FIG. 7 is a diagram illustrating an example of distributed processing of an NN model in a 5G network including the IAB.

### MODE FOR CARRYING OUT THE INVENTION

### First Embodiment

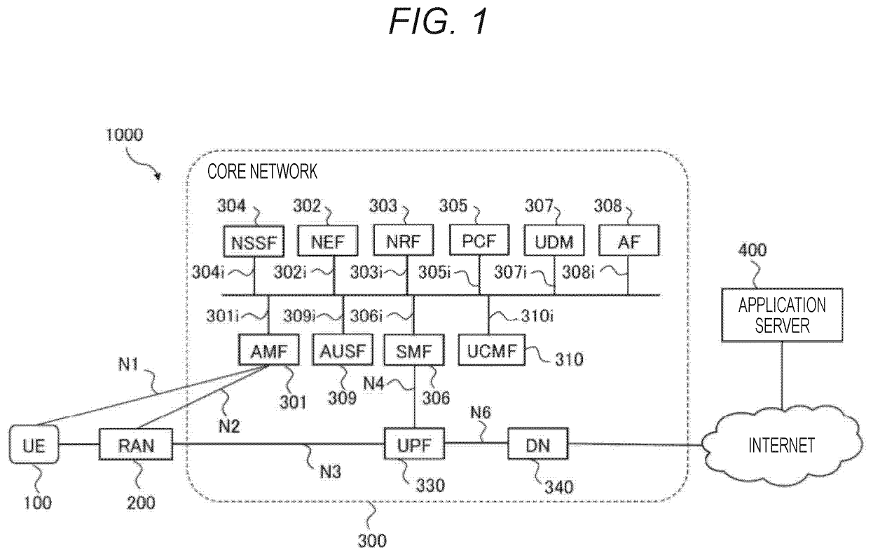

FIG. 1 is a diagram illustrating a configuration of a network architecture of a 5G system 1000 and a peripheral system.

The 5G system 1000 includes user equipment (UE) 100, a radio access network (RAN) 200, and a core network 300.

The 5G system 1000 is connected to an application server 400 via the Internet. Note that the application server 400 may be configured as a device of the core network 300.

The UE 100 is a plurality of wireless terminals connected to the 5G system 1000. The UE 100 is, for example, a smartphone or a mobile personal computer. The UE 100 is a terminal capable of operating an AI application, and can use the application on the 5G service via the 5G system 1000.

The AI application is arithmetic processing (first arithmetic processing) related to artificial intelligence (AI) or machine learning. The application is, for example, augmented reality (AR), automated driving, robotics (robot control), image recognition, voice recognition, or the like. The AI application is processed by distributed processing and integrated learning processing. Processing of the application requires processing capability and a low delay of the network.

In an embodiment of the present disclosure, the UE 100 includes a wireless terminal (first communication device) on which the AI application is operated and a wireless terminal (second communication device) on which arithmetic processing (second arithmetic processing) other than the AI application is operated, but may be another type of terminal.

For example, the wireless terminal on which arithmetic processing other than the AI application is operated may be a wireless base station, a core network, or a server connected via a core network.

The RAN 200 is a wireless access network that connects terminals and a trunk communication network.

In the embodiment of the present disclosure, the RAN 200 wirelessly connects the UE 100 as a terminal to the core network 300 as a trunk communication network, and is also referred to as a next generation (NG)-RAN.

The RAN 200 constitutes a network by a wireless base station 20 called a gNB or an ng-eNB and an integrated access and backhaul (IAB, backhaul link) 50.

In the embodiment of the present disclosure, the RAN 200 constitutes a network by a plurality of wireless base stations 20, and functions as a distributed network capable of performing distributed processing among multiple nodes. The wireless base station 20 functions as a wireless communication unit that directly communicates with the UE 100.

The wireless base station 20 may communicate with the UE 100 as the RAN 200, that is, as a distributed network capable of performing distributed processing among multiple nodes.

The wireless access network may, for example, enable connection to an access network other than the next generation (NG)-RAN and the wireless access network.

In the embodiment of the present disclosure, the RAN 200 is a wireless access network, but may be other network, for example, an access network (AN) or the like.

The core network 300 is a trunk communication network or a backbone which is a core of an information communication network, and is also referred to as 5 GC (5G CORE) or NGC (NG CORE).

The core network 300 includes multiple functional groups to be described later, and is connected to the RAN 200 and the Internet.

The multiple functional groups of the core network 300 functions as a communication control device.

The core network 300 is connected to the wireless base station 20 (first wireless base station) that is connected to the wireless terminal (first wireless terminal) on which the AI application is operated. In the wireless terminal, communication processing (first communication processing) related to the AI application is operated as specific processing.

The core network 300 is connected to the wireless base station 20 (second wireless base station) that is connected to the wireless terminal (second wireless terminal) on which processing other than the AI application is operated. In the wireless terminal, communication processing (second communication processing) related to processing other than the AI application is operated as processing other than the specific processing.

For example, a functional group of a control plane of the core network 300 includes a plurality of network functions (NFs) including an access and mobility management function (AMF) 301, a network exposure function (NEF) 302, a network repository function (NRF) 303, a network slice selection function (NSSF) 304, a policy control function (PCF) 305, a session management function (SMF) 306, a unified data management (UDM) 307, an application function (AF) 308, an authentication server function (AUSF) 309, and a UE radio capability management function (UCMF) 310.

The UDM 307 includes a unified data repository (UDR) that holds and manages subscriber information, and a front end (FE) unit that processes the subscriber information. The AMF 301 performs mobility management. The SMF 306 performs session management. The UCMF 310 holds UE radio capability information corresponding to all UE radio capability IDs in a public land mobile network (PLMN). The UCMF 310 is responsible for assigning each PLMN-assigned UE radio capability ID.

Nam 301i is a service-based interface provided by the AMF 301. NNef 302i is a service-based interface provided by the NEF 302. NNrf 303i is a service-based interface provided by the NRF 303. NNssf 304i is a service-based interface provided by the NSSF 304. Npcf 305i is a service-based interface provided by the PCF 305. Nsmf 306i is a service-based interface provided by the SMF 306. Nudm 307i is a service-based interface provided by the UDM 307. Naf 308i is a service-based interface provided by the AF 308. Nausf 309i is a service-based interface provided by the AUSF 309. Nucmf 310i is a service-based interface provided by the UCMF 310.

Each NF exchanges information between with another NF via each service-based interface.

A user plane function (UPF) 330 has a function of user plane processing. A data network (DN) 340 has a function of enabling connection to a service unique to a mobile network operator (MNO), the Internet, or a third-party service.

The UPF 330 functions as a transfer processing unit for user plane data processed by the application server 400.

The UPF 330 also functions as a gateway connected to the wireless base station 20.

Information is exchanged between the UE 100 and the AMF 301 via a reference point N1. Information is exchanged between the RAN 200 and the AMF 301 via a reference point N2. Information is exchanged between the RAN 200 and the UPF 330 via a reference point N3. Information is exchanged between the SMF 306 and the UPF 330 via a reference point N4. Information is exchanged between the RAN 200 and the DN 340 via a reference point N6.

In the SMF 306, QOS control for every service data flow applicable to both IP and Ethernet type data flows (service data flows) is executed. With the Qos control for every service data flow, the SMF 306 provides authorized QOS for each specific service. An index such as QOS subscriber information may be utilized in conjunction with policy rules such as service-based, subscription-based, and predefined PCF internal policies.

The SMF 306 uses a policy and charging control (PCC) rule related to a QoS flow (QOS-controlled data flow) to determine Qos to be authorized for the QOS flow. When the Qos flow is deleted, the SMF 306 can notify the PCF 305 of the fact that the QoS flow has been deleted. Furthermore, in a case where a guaranteed bit rate of the QOS flow, that is, a guaranteed flow bit rate (GFBR) cannot be guaranteed, the SMF 306 can notify the PCF 305 of the fact that the GFBR cannot be guaranteed.

As a QoS reservation procedure of the QoS flow, a UE-initiated QoS flow can be established. Alternatively, QoS requested as a part of change processing can be downgraded or upgraded.

The application server 400 processes an application. In the embodiment of the present disclosure, the application server 400 can process the AI application operating in the UE 100, by connecting to the 5G system 1000 via the Internet.

In a case where an entity providing the application has a subscription such as a service level agreement (SLA) with a public land mobile network (PLMN) operator providing the 5G service, the application server 400 can be disposed in the core network as the DN 340. The application server 400 may be provided in a form of an edge server.

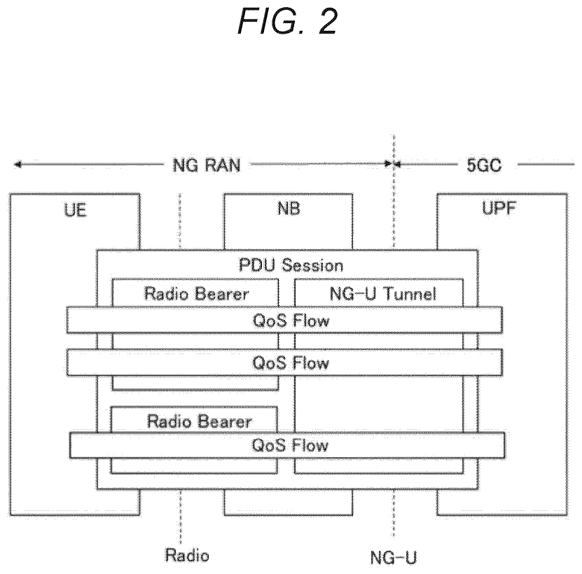

FIG. 2 illustrates an example QOS architecture. In the Qos model in 5G, a guaranteed flow bit rate (GBR) QOS flow and a non-GBR QOS flow are supported. The GBR QOS flow corresponds to a bandwidth-guaranteed Qos flow, and the non-GBR QOS corresponds to a non bandwidth-guaranteed QOS flow. At a non-access stratum (NAS) level, different QoS within a protocol data unit (PDU) session can be handled at QoS flow granularity. The QoS flow is encapsulated on the NG-U interface. The QoS flow is identified within the PDU session by a Qos flow ID (QFI) carried as a header.

For the UE 100, the wireless base station 20 can establish a data radio bearer (DRB) that is at least one radio bearer together with the PDU session, and can further establish an additional DRB. The DRB is a logical path for transmitting data. The RAN 200 and the core network 300 ensure quality of service by allocating packets to QoS and the DRB suitable for the service.

Two stages are performed: mapping of an IP flow and a Qos flow in non-access stratum (NAS), and mapping of a QoS flow and a DRB in access stratum (AS).

At the non-access stratum (NAS) level, the QoS flow is characterized by a QoS profile (second profile information) provided from the core network 300 to the RAN 200, and a QoS rule(s) provided from the core network 300 to the UE 100.

The Qos profile is used by the wireless base station 20 to determine a processing method on a wireless interface. Whereas, the QoS rule is used to instruct the UE 100 to perform mapping of uplink user plane traffic and QoS.

The QoS profile is provided by the SMF 306 to the RAN 200 via the AMF 301 via the reference point N2, or is provided by being set in the wireless base station 20 in advance.

The SMF 306 can provide one or more QoS rules and, if necessary, QoS flow-level QoS parameters associated with these QoS rules via the AMF 301, to the UE 100 via the reference point N1. Additionally or alternatively, the UE 100 can apply reflective QoS control. Here, the reflective Qos control is Qos control of monitoring the QFI(s) of a downlink packet and applying the same mapping to uplink.

The Qos flow can be either a GBR (bandwidth-guaranteed) or a non-GBR (non bandwidth-guaranteed) flow type according to the Qos profile. The QoS profile of the QOS flow includes, for example, parameters such as a 5G QOS identifier (5QI) and allocation and retention priority (ARP).

The ARP includes information regarding a priority level (priority), pre-emption capability, and pre-emption vulnerability. The priority level of ARP defines relative importance of the Qos flow, and is set in a range of 1 to 15 with the highest importance as 1.

The pre-emption capability of the ARP is an index that defines whether or not the QOS flow can use a resource already allocated to another Qos flow having a lower priority.

The pre-emption vulnerability of the ARP is an index that defines whether or not a resource allocated to the Qos flow is yielded to another QoS flow having a higher priority.

Either “enabled” or “disabled” is set in the pre-emption capability of the ARP and the pre-emption vulnerability of the ARP.

In a case of the GBR QOS flow, the QoS profile includes guaranteed flow bit rates (GFBRs) of uplink and downlink, maximum flow bit rates (MFBGs) of uplink and downlink, maximum packet loss rates of uplink and downlink, Delay Critical Resource Type, Notification Control, and the like. Furthermore, in a case of the non-GBR Qos flow, the Qos profile includes a reflective QOS attribute (RQA), additional QOS flow information, and the like.

Notification Control of the QoS parameter indicates whether or not a notification from the RAN 200 is requested when the GFBR cannot be satisfied for the QOS flow. For a certain GBR QOS flow, when Notification Control is “enable” and it is determined that the RAN cannot satisfy the GFBR, then the RAN 200 must send a notification to the SMF 306. At that time, the wireless base station 20 must maintain the QoS flow unless the RAN 200 is in a special state of requesting release of RAN resources of this GBR QOS flow, for example, a state of radio link failure or RAN internal congestion. When the wireless base station 20 determines that the GFBR can be satisfied again, the wireless base station 20 sends a new notification to that effect to the SMF 306.

An aggregate maximum bit rate (AMBR) is related to Session-AMBR of each PDU session and a UE-AMBR of each UE. The Session-AMBR limits an aggregate bit rate expected to be provided across all non-GBR QOS flows for a specific PDU session, and is managed by the user plane function (UPF) 330. The UE-AMBR limits an aggregate bit rate expected to be provided across all non-GBR Qos flows for certain UE 100, and is managed by the wireless base station 20.

The 5QI relates to QOS features, and provides guidelines (policies) for setting a node-specific parameter for each Qos flow. The standardized or preset 5G QOS features can be known from the 5QI, and are not explicitly signaled. Signaled QoS features can be included as part of the Qos profile. The Qos feature includes elements such as Priority level (priority), Packet Delay Budget (packet delay allowable time), Packet Error Rate, Averaging window, and Maximum Data Burst Volume. The packet delay allowable time may include a packet delay allowable time in the core network 300.

At an access stratum (AS) level, the DRB (radio bearer) defines a packet processing method at a wireless interface (interface Uu). Any DRB provides the same packet transfer processing for packets. The RAN 200 allocates (maps) QOS flows to the DRBs on the basis of Qos profiles associated with QFI (QOS Flow ID). Another DRB can be established for packets requesting different packet transfer processing (see FIG. 2). Alternatively, multiple Qos flows belonging to the same PDU session can be multiplexed into the same DRB (see FIG. 2).

On uplink, mapping of QOS flows to the DRBs is controlled by mapping rules signaled in two different methods.

One method is referred to as Reflective mapping, in which, for each DRB, the UE 100 monitors the QFI(s) of downlink packets and applies the same mapping to uplink.

Another method is referred to as Explicit Configuration, and the mapping rule of the Qos flows to the DRBs is explicitly signaled by radio resource control (RRC).

In downlink, the QOS flow ID (QFI) is signaled on the interface Uu by the wireless base station 20 for reflective quality of service (RQOS). Unless both the wireless base station 20 and the non-access stratum (NAS) use Reflective mapping for the Qos flow carried in a certain DRB, the QFI for that DRB is not signaled on the interface Uu. On uplink, the wireless base station 20 can set the UE 100 to signal the QFI on the interface Uu.

For each PDU session, a default DRB may be set. In a case where an uplink packet does not conform to either Explicit Configuration or Reflective mapping, the UE 100 maps the packet to the default DRB of the PDU session. For a non-GBR QOS flow, the core network 300 may send additional Qos flow information parameters related to any QoS flow to the wireless base station 20, to instruct an increase of a frequency of certain traffic relative to other non-GBR QOS flows established on the same PDU session.

The wireless base station 20 can determine how to map multiple QOS flows to one DRB within the PDU session.

For example, the wireless base station 20 may map the GBR flow and the non-GBR flow to the same DRB or to different DRBs.

The wireless base station 20 may map a plurality of GBR flows to the same DRB or to different DRBs.

In the 5G NR, a service data adaptation protocol (SDAP) sublayer is newly introduced for QoS control via a Qos flow. By the SDAP sublayer, traffic of the QoS flow is mapped to an appropriate DRB. The SDAP sublayer may have multiple SDAP entities, and has an SDAP entity for every PDU session on the interface Uu. The SDAP entity is established or released by radio resource control (RRC). The QOS flow is identified by using QFI in PDU Session Container included in a GTP-U header. The PDU session is identified using a GTP-U tunnel endpoint identifier (TEID). The SDAP sublayer maps each QoS flow to a specific DRB.

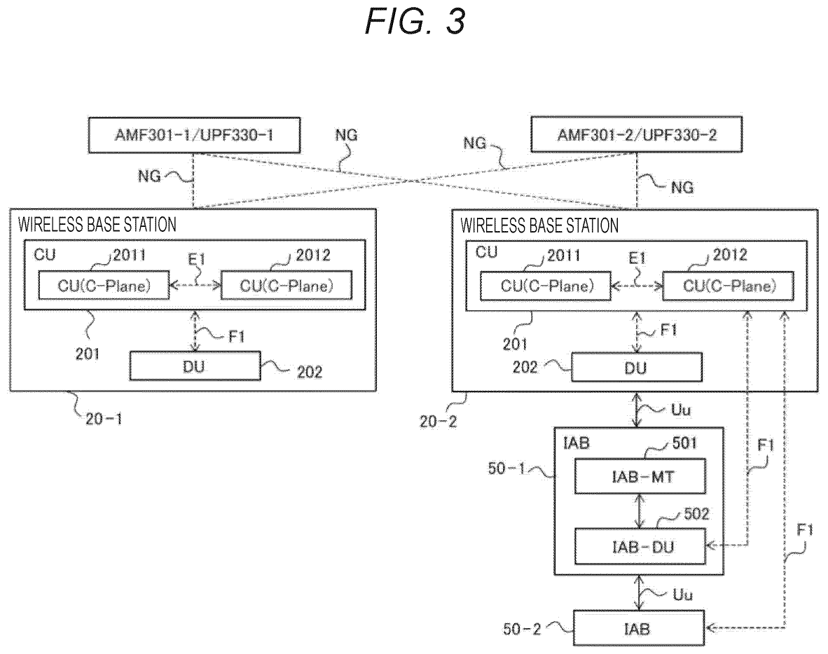

FIG. 3 is a diagram illustrating an example of a configuration of a 5G network architecture including integrated access and backhaul (IAB).

The network of the 5G system 1000 includes the core network 300 and the RAN 200.

The wireless base station 20 is connected to the AMF 301 or the UPF 330 via an interface NG.

For example, a wireless base station 20-1 which is one of the wireless base stations 20 is connected to an AMF 301-1 or an AMF 301-2 which is one of the AMFs 301, via an interface NG-C which is a control plane of the interface NG. For example, the wireless base station 20-1 which is one of the wireless base stations 20 is connected to an UPF 330-1 or an UPF 330-2 which is one of the UPFs 330, via an interface NG-U which is a user plane of the interface NG.

The wireless base station 20 includes a central unit (CU) 201 and a distributed unit (DU) 202, which are connected via an interface F1. The central unit (CU) 201 includes a CU (C-Plane) 2011 that processes a control plane and a CU (U-Plane) 2012 that processes a user plane, which are connected via an interface E1.

Similarly, a wireless base station 20-2 which is one of the wireless base stations 20 is connected to the AMF 301-1 or the AMF 301-2 which is one of the AMFs 301, via an interface NG-C which is a control plane of the interface NG.

Similarly, the wireless base station 20-2 which is one of the wireless base stations 20 is connected to the UPF 330-1 or the UPF 330-2 which is one of the UPFs 330, via an interface NG-U which is a user plane of the interface NG.

The wireless base station 20-2 is connected to an IAB 50-1 and an IAB 50-2, which are nodes of the IAB 50, as an IAB-donor node. The wireless base station 20-2 constitutes the RAN 200 together with the IAB 50-1 and the IAB 50-2.

The DU 202 of the wireless base station 20-2 as a parent node is connected via the interface Uu with an IAB-mobile termination (MT) 501 treated as a function equivalent to the UE in the IAB 50-1 as a child node.

The CU 202 of the wireless base station 20-2 as a parent node is connected to an IAB-DU 502 of the IAB 50-1 as a child node, via the interface F1 on the interface Uu.

The IAB-DU 502 of the IAB 50-1 as a parent node is connected to an IAB-MT 501 of the IAB 50-2 as a child node, via the interface Uu. Moreover, the CU 202 of the wireless base station 20-2 as a parent node is connected to the IAB-DU 502 of the IAB 50-2 as a child node, via the interface F1 on the interface Uu via the IAB 50-1 which is a relay node.

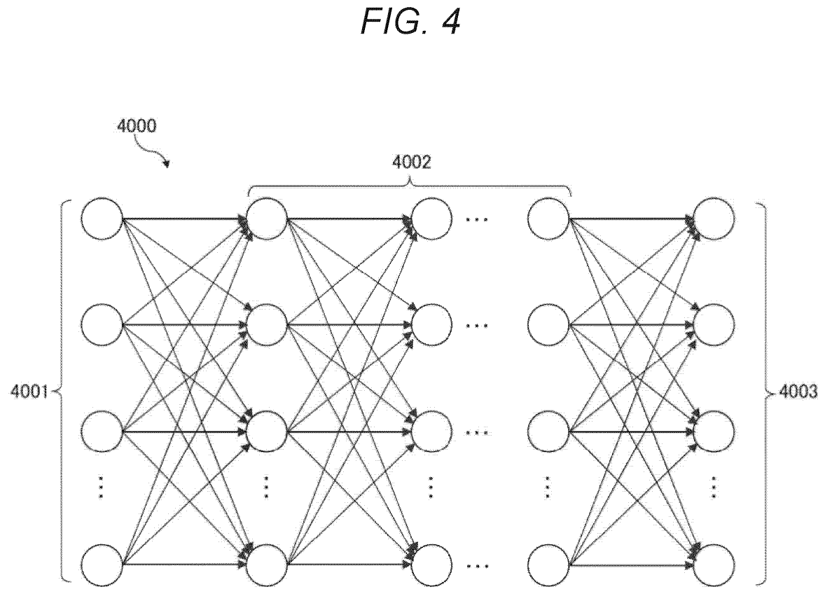

FIG. 4 illustrates an example of a configuration of a deep neural network (DNN) model used in deep learning.

A neural network model 4000 includes layers called an input layer 4001 including multiple nodes, a hidden layer 4002, and an output layer 4003. Note that the hidden layer 4002 is also referred to as an intermediate layer.

Nodes of the neural network model 4000 are connected via edges. The input layer 4001, the hidden layer 4002, and the output layer 4003 have a function called an activation function, and are weighted for every edge.

The deep neural network model includes multiple hidden layers 4002. In machine learning, a neural network model is used in which the number of hidden layers 4002 is limited due to a limit of processing capability of a computer.

In deep learning, a DNN model, which is a form of an NN model having a larger number of hidden layers 4002, is used due to improvement in processing capability of a computer. By using a trained DNN model that has been trained using a huge amount of data, accuracy of recognition, determination, or estimation is improved.

Examples of a common algorithm used in deep learning include a convolutional neural network (CNN), recursive neural network (RNN), long short-term memory (LSTM), and the like.

In the CNN, the hidden layer 4002 includes layers called a convolution layer and a pooling layer. In the convolution layer, filtering is performed by a convolution operation, and data called a feature map is extracted. In the pooling layer, information of the feature map output from the convolution layer is compressed, and down-sampling is performed.

The RNN has a network structure in which a value of the hidden layer 4002 is recursively input to the hidden layer 4002, and for example, short-period time-series data is processed.

In the LSTM, an influence of a far past output can be held by introducing a parameter called a memory cell that holds a state of the hidden layer for a hidden layer output of the RNN. The LSTM processes time-series data of a longer period than the RNN.

Examples of representative technical areas in which deep learning is utilized include four fields of image recognition, voice recognition, natural language processing, and failure detection by robots. In image recognition, deep learning is used for purposes such as tagging of a person on a social network service (SNS) and automated driving. In voice recognition, deep learning is applied to smart speakers and the like. In natural language processing, deep learning is applied to search by a browser and automatic translation. In failure detection by robots, deep learning is used in airports, railways, manufacturing sites, and the like.

When the UE 100 executes AI application processing using an NN model, arithmetic processing of the NN model can be distributed. In the NN model, in order to distribute arithmetic processing of one NN model among multiple devices, the NN model is split at any splitting point for split pf multiple layers constituting the NN model, and hidden layer data at the splitting point of the NN model is transmitted via wireless communication.

The NN model is trained, for example, offline in the application server 400.

The application server 400 creates profile information (first profile information) of the NN model.

The profile information of the NN model includes, for example, a relationship between an error rate for every splitting point of the NN model, for example, a block error ratio (BLER), and final inference accuracy of an output value output by the neural network model. That is, the profile information of the NN model includes a relationship between the block error ratio (BLER) for every splitting point of the NN model and the final inference accuracy of the AI application.

The profile information of the NN model includes information regarding NN model splitting setting.

The profile information of the NN model includes a data size of hidden layer data for every splitting point of the NN model. Furthermore, the application server 400 may manage inference accuracy required for the NN model for every application, specify a lower limit of the BLER satisfying the inference accuracy for every splitting point of the NN model, and include a lower limit value of the BLER in the profile information of the NN model.

The application server 400 may create the profile information of the NN model for every type of a sending method. The type of the sending method is, for example, a technique for processing sending data in advance, and is presence or absence of scrambling and a scrambling technique, presence or absence of interleaving and an interleaving technique, presence or absence of data compression including a deep learning based compression method for compressing hidden layer data and a data compression method, and the like.

The profile information is, for example, information in which accuracy information for every error rate value, for example, for every BLER value, is collected on the basis of presence or absence of Scramble.

The profile information determines granularity of the BLER value and the accuracy information in accordance with a data size of the profile information.

The profile information may also include a model ID which is an ML model number, a splitting point, and the like.

In a case of managing NN models of multiple types, the application server 400 creates and manages the profile information of the NN model for every type of NN model.

The application server 400 may include a plurality of servers, and may manage the NN model for every application for every server.

The application is identified by an application ID. The NN model is identified by an NN model ID. Moreover, the splitting point of the NN model is identified by a splitting point ID.

When the application is specified, the NN model to be used can be specified by the NN model ID corresponding to the application ID. Moreover, when the splitting point is specified, the profile information of the NN model corresponding to the splitting point ID can be specified by the splitting point ID.

In a case where one application corresponds to multiple types of NN models, when the application and the type of the NN model are specified, the NN model to be used can be specified by the application ID and the NN model ID.

The splitting point of the NN model can be determined by any method by a splitting unit that determines the splitting point.

For example, in a case where AI processing is performed in the 5G system 1000, any case is conceivable such as a case where processing is performed only by a network device, a case where processing is performed in a distributed manner by a terminal and a network device, and a case where processing is performed only by a terminal.

For example, in the case where processing is performed only by a network device, the AI processing is performed by the application server 400 connected via the Internet, in addition to the network devices included in the RAN 200 and the core network 300.

For example, in the case where processing is performed in a distributed manner by a terminal and a network device, the AI processing is performed in a distributed manner by the application server 400 connected via the Internet, in addition to the UE 100 as the terminal and the network devices included in the RAN 200 and the core network 300.

Hereinafter, as a case of distributing the AI processing, a case where the processing is performed in a distributed manner by a network device and a terminal in which the number of splits of the NN model is two will be described.

As a method of determining a splitting point, there are a method of determining a splitting point in advance, a method of determining a splitting point on the basis of a data rate of Qos, and a method of determining a splitting point on the basis of a PER of QoS.

For example, in the method of determining a splitting point in advance, the application server 400 or the DN 340 determines a splitting point with respect to the number of splits in advance for every NN model.

In this method, the application server 400 or the DN 340 functions as the splitting unit.

The AF 308 acquires information regarding traffic of the RAN 200 and the UPF 330 via the AMF 301 and the SMF 306, via the service-based interface described above as a function of the control plane of the application server 400. The information regarding traffic is, for example, information such as a traffic load, a data rate, and a transmission delay. The application server 400 determines the number of splits on the basis of the acquired information regarding traffic.

The splitting point with respect to the number of splits is managed as the information regarding NN model splitting setting.

Since the profile information of the NN model includes the information regarding NN model splitting setting, the splitting point determined in advance is stored in the profile information of the NN model.

For the application used by the UE 100, the NN model to be used is determined for every application.

The NN model is specified by determining the application used by the UE 100. In this case, since the splitting point is determined in advance, the splitting point of the NN model corresponding to two as the number of splits is uniquely determined.

The RAN 200 acquires the information regarding the splitting point via N2 SM information received from the SMF 306. The RAN 200 may treat the predetermined splitting point as a default splitting point.

For example, in the method of determining a splitting point on the basis of a data rate of Qos, the wireless base station 20 determines the splitting point on the basis of the QFI, the Qos profile, and the profile information of the NN model.

In this method, the wireless base station 20 functions as the splitting unit.

The profile information of the NN model includes, for example, information about a data size of hidden layer data for every splitting point.

The wireless base station 20 specifies 5QI to apply for hidden layer data sending from the QoS profile corresponding to the QFI.

In the specified 5QI, a resource type (GBR (bandwidth-guaranteed) or non-GBR (non bandwidth-guaranteed)), Priority level (priority), Packet Delay Budget (packet delay allowable time), Packet Error Rate, Averaging window, Maximum Data Burst Volume, and the like are set in advance.

For example, when the wireless base station 20 determines whether or not a guaranteed flow bit rate (GFBR) in a case of a GBR QOS flow or the UE-AMBR in a case of a non-GBR QOS flow is a data rate sufficient to send the data size of the hidden layer data, the wireless base station 20 estimates time required for sending on the basis of the data size of the hidden layer data and the GFBR or the UE-AMBR.

The wireless base station 20 specifies, on the basis of the GFBR or the UE-AMBR, a type of the NN model and a splitting point candidate that allow sending of the hidden layer data within preset time.

When estimating the time required for sending on the basis of the data size of the hidden layer data and the GFBR or the UE-AMBR, the wireless base station 20 may take into account Packet Delay Budget of the specified 5QI.

In a case where there are multiple types of the NN model and splitting point candidates, the wireless base station 20 may determine a splitting point on the basis of processing capability of the UE 100.

For example, if the processing capability of the UE 100 is large, a type of the NN model and a splitting point with which the UE 100 can process more layers are determined.

For example, when the processing capability of the UE 100 is small, a type of the NN model and a splitting point for processing more layers by the application server 400 are determined.

The processing capability of the UE 100 may be managed as UE radio capability, or may be provided from the UE 100 to the RAN 200 as an information element (IE).

Here, the processing capability of the UE 100 is processing capability of a processor such as a central processing unit (CPU), a micro-processing unit (MPU), or a graphics processing unit (GPU), or processing capability of a wireless communication unit of the UE 100. The processing capability of the wireless communication unit is, for example, a parameter related to an effect of spatial multiplexing, such as the number of antenna ports and the number of layers of MIMO, a parameter related to improvement of a signal to noise ratio (SNR), such as the number of beams that can be sent and received at the same time, a parameter related to extension of a bandwidth to be sent and received, such as dual connectivity (DC)/carrier aggregation (CC), or the like. Note that each beam is identified for each synchronization signal block (SS)/physical broadcast channel (PBCH).

Furthermore, in a case where there are multiple types of the NN model and splitting point candidates, the wireless base station 20 may determine a splitting point on the basis of an arithmetic load of the UE 100.

For example, when the arithmetic load of the UE 100 is low, a type of the NN model and a splitting point with which the UE 100 can process more layers are determined.

For example, when the arithmetic load of the UE 100 is high, a type of the NN model and a splitting point for processing more layers by the application server 400 are determined.

When the arithmetic load becomes a certain threshold (for example, 70%) or more, the UE 100 may report the arithmetic load to the wireless base station 20.

Furthermore, in a case where there are multiple types of the NN model and splitting point candidates, the wireless base station 20 may determine a splitting point on the basis of a remaining level of a battery of the UE 100.

For example, if the remaining level of the battery of the UE 100 is large, a type of the NN model and a splitting point with which the UE 100 can process more layers are determined.

For example, when the remaining level of the battery of the UE 100 is small, a type of the NN model and a splitting point for processing more layers by the application server 400 are determined.

When the remaining level of the battery becomes less than a certain threshold (for example, 40%), the UE 100 may report the remaining level of the battery to the wireless base station 20.

The wireless base station 20 may determine a splitting point having the smallest data size, on the basis of the information about the data size of the hidden layer data for every splitting point.

For example, if the processing capability of the UE 100 and the application server 400 is sufficient, a wireless access network portion between the UE 100 and the RAN 200 becomes a bottleneck in the network from the UE 100 to the application server 400.

The RAN 200 can minimize a transmission delay of a wireless access network portion that is a bottleneck, by determining the splitting point having the smallest data size.

The wireless base station 20 may determine a splitting point on the basis of the number of nodes constituting a layer of the NN model, instead of the data size of the hidden layer data.

In a case where there are multiple types of the NN model and splitting point candidates, the wireless base station 20 may determine a type of the NN model and a splitting point that allow improvement of reliability by performing scrambling or/and interleaving at the time of sending, within a range that allows sending within preset time.

In a case where there are multiple types of the NN model and splitting point candidates, it is possible to determine a type of the NN model and a splitting point that allow compression of the data size of the hidden layer data by performing data compression at the time of sending, within a range that allows sending within preset time.

The scrambling, the interleaving, or the data compression at the time of sending may be considered in a case where a type of the NN model and a splitting point candidate cannot be specified in data rate criteria of the GFBR or the UE-AMBR.

For example, the wireless base station 20 can specify a type of the NN model and a splitting point candidate that allow improvement of reliability by performing scrambling or/and interleaving at the time of sending, or a type of the NN model and a splitting point candidate that allow sending of compressed hidden layer data, with the GFBR or the UE-AMBR within a range that allows sending within preset time.

For example, in the method of determining a splitting point on the basis of a PER of Qos, the wireless base station 20 specifies the type of the NN model and the splitting point candidate on the basis of a lower limit value of the BLER for every splitting point of the NN model included in the profile information of the NN model.

In this method, the wireless base station 20 functions as the splitting unit.

The wireless base station 20 can specify a type of the NN model and a splitting point candidate on the basis of packet error rate (PER) of the specified 5QI and the lower limit value of the BLER for every splitting point of the NN model.

The wireless base station 20 may monitor communication quality between with the UE 100, for example, the SNR, and specify the type of the NN model and the splitting point candidate on the basis of the BLER corresponding to the communication quality.

The wireless base station 20 may dynamically change the splitting point of the NN model on the basis of the dynamically changing communication quality and the lower limit value of the BLER for every splitting point of the NN model.

In a case where none of the lower limit values of the BLER for every splitting point of the NN model satisfies the PER of the current 5QI, the wireless base station 20 may send a message requesting the AMF 301 to change the QFI, for example, PDU Session Modification Request.

The wireless base station 20 may include a requested PER value or a requested QFI in the message.

Upon receiving the PDU Session Modification Request message from the RAN 200, the AMF 301 sends a message (for example, Nsmf_PDUSession_UpdateSMContext Request) requesting the SMF 306 to change the QFI allocated to the current PDU session. As a result, the AMF 301 can request a change of QoS.

The AMF 301 can include PDU Session ID and the requested QFI in the message.

The SMF 306 receives a message requesting a change of the QFI. The SMF 306 allocates a new QFI to the PDU session when permitting the requested QFI. The SMF 306 responds with an Nsmf_PDUSession_UpdateSMContext Response message. The SMF 306 notifies the RAN 200 of the updated QFI and QoS profile via the AMF 301.

The RAN 200 specifies the type of the NN model and the splitting point candidate on the basis of a PER of the 5QI specified via the new QoS profile and the lower limit value of the BLER for every splitting point of the NN model.

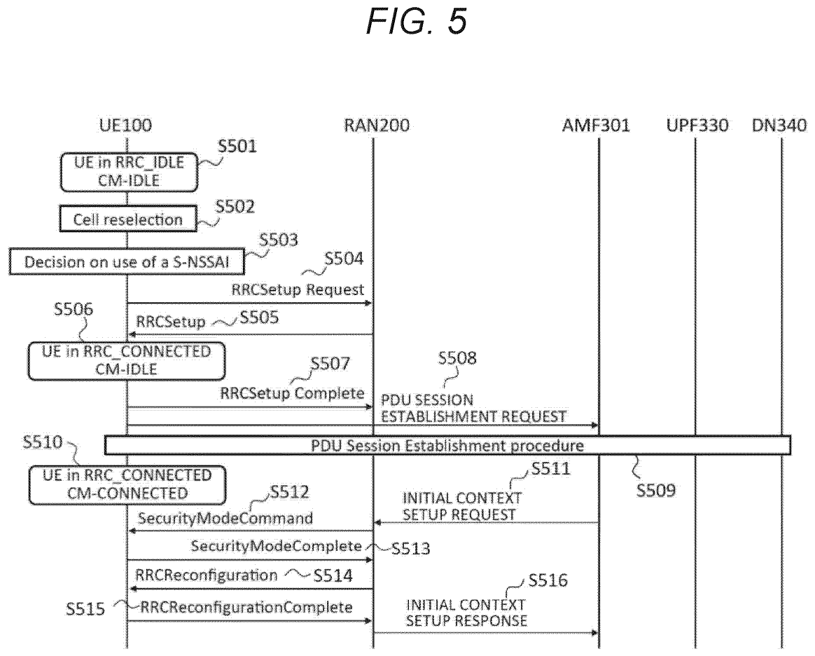

FIG. 5 is a diagram illustrating an example of connection processing of the 5G system 1000.

The UE 100 in a state of RRC_IDLE and CM-IDLE (S501) performs cell reselection processing, and camps on Suitable cell satisfying a predetermined criterion (S502).

When determining use of an application that utilizes a neural network (NN) model for artificial intelligence (AI), the UE 100 specifies a network slice corresponding to the application that utilizes the NN model (S503).

By specifying the network slice, the UE 100 selects single network slice selection assistance information (S-NSSAI) corresponding to the specified application from Allowed NSSAI (NSSAI).

The S-NSSAI is information for assisting selection of the network slice, and includes a set of a mandatory slice/service type (SST) constituted by 8 bits for identifying a type of the slice (slice type) and an optional slice differentiator (SD) constituted by 24 bits for distinguishing different slices in the same SST.

The UE 100 sends an RRCSetup Request message to the wireless base station 20 that is camped on (S504).

The UE 100 receives the RRCSetup message from the wireless base station 20 (S505).

The UE 100 transitions to a state of RRC_CONNECTED and CM-IDLE (S506).

The UE 100 responds to the wireless base station 20 with the RRCSetup Complete message, to complete RRC setting (S507).

The UE 100 sends a PDU SESSION ESTABLISHMENT REQUEST message, which is a NAS message, to the AMF 301 (S508).

PDU session establishment processing to be described later is executed between the UE 100 and the DN 340 via the wireless base station 20-1 and the UPF 330 (S509).

The UE 100 enters a state of RRC_CONNECTED and CM-CONNECTED (S510).

The PDU SESSION ESTABLISHMENT REQUEST message can include the S-NSSAI selected by the UE 10.

The AMF 310 generates UE context data including a PDU session context, a security key, UE Radio capability, UE security capabilities, and the like.

The AMF 310 sends the UE context data to the wireless base station 20 by using an INITIAL CONTEXT SETUP REQUEST message (S511).

The wireless base station 20 sets the UE context of the UE 100. The INITIAL CONTEXT SETUP REQUEST message includes Allowed NSSAI, and can further include the S-NSSAI for every PDU session.

The wireless base station 20 sends a SecurityModeCommand message to the UE 100 (S512).

The wireless base station 20 notifies the UE 100 of an integrity algorithm selected by using the SecurityModeCommand message. The UE 100 verifies integrity of the received message to confirm validity of the message, and responds with a SecurityModeComplete message (S513).

The wireless base station 20 notifies the UE 100 of an RRCReconfiguration message in order to set a signaling radio bearer (SRB) 2 and a data radio bearer (DRB) (S514).

When the SRB 2 and the DRB are established between the UE 100 and the wireless base station 20, the wireless base station 20 receives an RRCReconfigurationComplete message from the UE 100 (S515).

The wireless base station 20 sends an INITIAL CONTEXT SETUP RESPONSE message to the AMF 301 to notify of completion of UE Context configuration processing (S516).

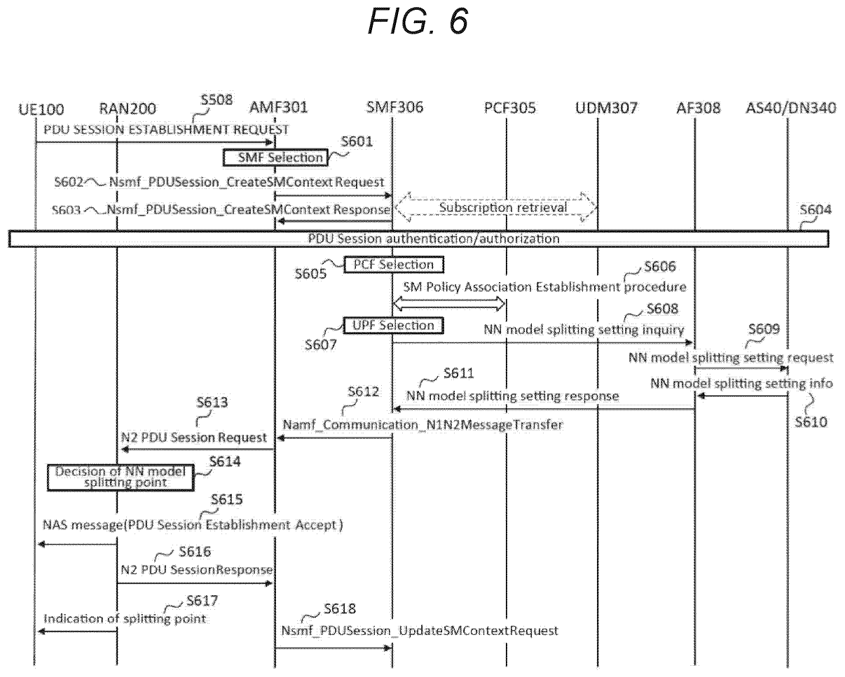

FIG. 6 illustrates an example of the PDU session establishment processing in S509.

The PDU session establishment processing in S509 is started when step S508 is completed.

The AMF 301 executes SMF selection processing (S601).

In the SMF selection processing, the AMF 301 determines whether the received PDU SESSION ESTABLISHMENT REQUEST message includes S-NSSAI.

In a case where the received PDU SESSION ESTABLISHMENT REQUEST message does not include S-NSSAI, the AMF 301 determines S-NSSAI for the requested PDU session from the current Allowed NSSAI of the UE 100.

The AMF 301 determines whether the Allowed NSSAI includes one piece of S-NSSAI.

If the Allowed NSSAI includes one piece of S-NSSAI, the AMF 301 uses the S-NSSAI included in the Allowed NSSAI.

If the Allowed NSSAI includes a plurality of pieces of S-NSSAI, the AMF 301 selects S-NSSAI in accordance with UE subscription of the UE 100 or a policy of a PLMN operator.

If the UE subscription includes only one piece of the default S-NSSAI, the AMF 301 selects this default S-NSSAI.

In a case where the PDU SESSION ESTABLISHMENT REQUEST message includes S-NSSAI but does not include a data network name (DNN), the AMF 301 determines a default DNN as a DNN for the S-NSSAI. Here, the DNN corresponds to an access point name (APN) used in a system in and before 4G.

The AMF 301 determines a locally configured DNN as the DNN for the S-NSSAI.

This similarly applies to a case where the UE 100 and the 5G network use an APN or an application server name (ASN) instead of the DNN.

The AMF 301 uses the NRF 303 for discovery of the SMF, unless information regarding the SMF is useful (for example, in a case of being locally set in the AMF) by other means.

When attempting to discover an SMF instance, the AMF 301 provides location information of the UE 100 to the NRF 303. In response, the NRF 303 provides the AMF 301 with an NF profile of the one or more SMF instances.

The NRF 303 provides the AMF 301 with information regarding a service area of the SMF instance.

The AMF 301 selects the SMF instance on the basis of information regarding an available SMF instance acquired from the NRF 303 or information about the SMF that is set in the AMF 301 in advance.

In the embodiment of the present disclosure, the AMF 301 selects the SMF 306, but may select another SMF. For example, in a case where there are multiple SMFs, an SMF other than the SMF 306 may be selected.

The SMF selection processing may be executed by a method other than the method based on the setting of the AMF 301.

For example, required information may be acquired from the NSSF 304 by disposing the NSSF 304 in a serving PLMN.

For example, in a case where the AMF 301 does not have valid information regarding the SMF 306, the AMF 301 may activate an NNssf_NSSelection_Get service for the NSSF 306, to acquire, from the NSSF 306, information required for selecting an SMF instance.

For example, the AMF 301 may consider the selected DNN and S-NSSAI, or optionally Network Slice Instance Identifier (NSI-ID) associated with the S-NSSAI, subscription information acquired from the UDM 307, and the like.

The AMF 301 sends an Nsmf_PDUSession_CreateSMContext Request message to the SMF 306 that is the SMF instance selected in the SMF selection processing (S602).

The Nsmf_PDUSession_CreateSMContext Request includes SUPI, S-NSSAI, UE Requested DNN, or DNN.

If Session Management Subscription data corresponding to the SUPI, the DNN, and the S-NSSAI is not available, the SMF 306 acquires Session Management Subscription data from the UDM 307 by using Nudm_SDM_Get.

The SMF 306 performs registration by using Nudm_SDM_Subscribe, and receives a notification when the Session Management Subscription data is updated.

If the SMF 306 can process PDU Session Establishment Request, the SMF 306 generates an SM context, and responds with Nsmf_PDUSession_CreateSMContext Response to the AMF 301 to provide an SM Context ID (S603).

In a case where second authentication and authorization processing by a DN-AAA server needs to be executed during PDU session establishment, the SMF 306 activates PDU session establishment authentication/authorization processing (S604).

In a case where dynamic policy and charging control (PCC) is applied to the PDU session to be established, the SMF 306 executes PCF Selection (S605).

The SMF 306 may apply a local policy to the PDU session to be established.

The SMF 306 may execute an SM Policy Association Establishment procedure to establish SM Policy Association between with the PCF 305, to acquire default PCC Rules for the PDU session (S606). As a result, the PCC Rules can be acquired before selecting the UPF 330.

The SMF 306 executes UPF selection to select one or more UPFs 330, and establishes an interface N4 between with the selected UPF 330 (S607).

When multiple UPF 330 are selected for the PDU session, the SMF 306 establishes the interface N4 for the individual UPF 330.

The SMF 306 sends an NN model splitting setting inquiry message to the AF 308 on the basis of S-NSSAI and a DNN (or an ASN) included in the Nsmf_PDUSession_CreateSMContext Request message (S608). As a result, it is possible to acquire information necessary for executing distributed processing of arithmetic operation of the NN model for S-NSSAI to be executed by the application server 400 or the DN 340.

The SMF 306 performs setting of the QFI(s) on the basis of the S-NSSAI.

The SMF 306 may consider a DNN (or an ASN) in setting of the QFI(s).

The AF 308 requests the application server 400 or the DN 340 for information regarding NN model splitting setting, in order to acquire the profile information of the NN model managed by the application server 400 or the DN 340 (S609).

The AF 308 acquires the information regarding NN model splitting setting from the application server 400 or the DN 340 (S610).

The information regarding NN model splitting setting includes at least the profile information of the NN model.

As a response to the NN model splitting setting inquiry, the AF 308 responds to the SMF 306 with an NN model splitting setting response message including the information regarding NN model splitting setting in the SMF 306 (S611).

The SMF 306 sends a Namf_Communication_N1N2MessageTransfer message to the AMF 301 (S612).

The Namf_Communication_N1N2MessageTransfer message includes PDU Session ID, N2 SM information, CN Tunnel Info, S-NSSAI, and N1 SM container. Here, the N2 SM information includes PDU Session ID, QFI(s), Qos Profile(s), the information regarding NN model splitting setting, and the like.

In a case where multiple UPF 330 are used for the PDU session, CN Tunnel Info includes tunneling information (tunnel information) related to these multiple UPF 330 that terminate N3.

The N1 SM container includes PDU Session Establishment Accept that the AMF 301 must provide to the UE 10.

The PDU Session Establishment Accept includes S-NSSAI.

The Namf_Communication_N1N2MessageTransfer message includes PDU Session ID so that the AMF 301 knows which access to use for the UE 10.

The AMF 301 sends an N2 PDU Session Request message to the RAN 200 (S613).

The AMF 301 sends a non-access-stratum (NAS) message including PDU Session ID whose destination is the UE 10 and the PDU Session Establishment Accept, and the N2 SM information received from the SMF 306, to the RAN 200 via the N2 PDU Session Request message.

The RAN 200 determines a splitting point of the NN model by a method to be described later, on the basis of the number of splits, QFI(s), Qos Profile(s), and the information regarding NN model splitting setting (S614).

The RAN 200 transfers the NAS message including the PDU Session ID and the N1 SM container, to the UE 100 (S615).

The N1 SM container includes the PDU Session Establishment Accept.

The RAN 200 responds to the AMF 301 with an N2 PDU Session Response message (S616).

The RAN 200 notifies the UE 100 of the determined splitting point of the NN model (S617).

The AMF 301 transfers the N2 SM information received from the RAN 200 to the SMF 306 via an

Nsmf_PDUSession_UpdateSMContext Request message that includes the SM Context ID and the N2 SM information (S618).

The SMF 306 activates N4 Session Modification procedure between with the UPF 330, and sends an N4 Session Modification Request message to the UPF 330.

The SMF 306 provides the UPF 330 with AN Tunnel Info in addition to a transfer rule.

The UPF 330 can perform setting regarding transfer of data of a neural network model processed by the UE 100 for every arithmetic processing according to the transfer rule.

The UPF 330 responds to the SMF 306 with an N4 Session Modification Response message.

In a case where multiple UPFs 330 are used in the PDU session, the above-described N4 Session Modification procedure is performed on all the UPFs 330 that terminate N3.

A method may be used other than the method in which the wireless base station 20 determines the splitting point on the basis of the QFI, the QoS profile, and the profile information of the NN model. For example, after the processing of S611, the SMF 306 may determine the splitting point with a similar method, and give notification to the RAN 200 via the AMF 301.

Although an example has been described in which the wireless base station 20 determines the splitting point on the basis of the data rate of QOS or the PER, the splitting point may be further determined on the basis of the data rate of QoS from among the NN model and splitting point candidates extracted on the basis of the PER.

In a case where handover from a source gNB to a target gNB, which are the wireless base stations 20, is executed according to mobility of the UE 100, the wireless base station 20 may re-execute NN model splitting point determination processing (S614). For example, the information regarding NN model splitting setting may be transferred to the target gNB via an Xn interface between the source gNB and the target gNB.

As described above, according to the embodiment of the present disclosure, multiple layers constituting a neural network model can be split on the basis of the profile information. That is, it is possible to improve a network delay in specific arithmetic processing, by setting a communication device that processes an arithmetic operation for every split neural network model.

As a result, an execution delay of specific arithmetic processing can be improved.

Here, an example of a relationship between the BLER for every splitting point of the NN model and final inference accuracy of the AI application has been described as the profile information of the NN model created by the application server 400, but the present disclosure is not limited to this example. For example, a bit error rate (BER) or a packet error rate (PER) may be used instead of the BLER.

### Second Embodiment

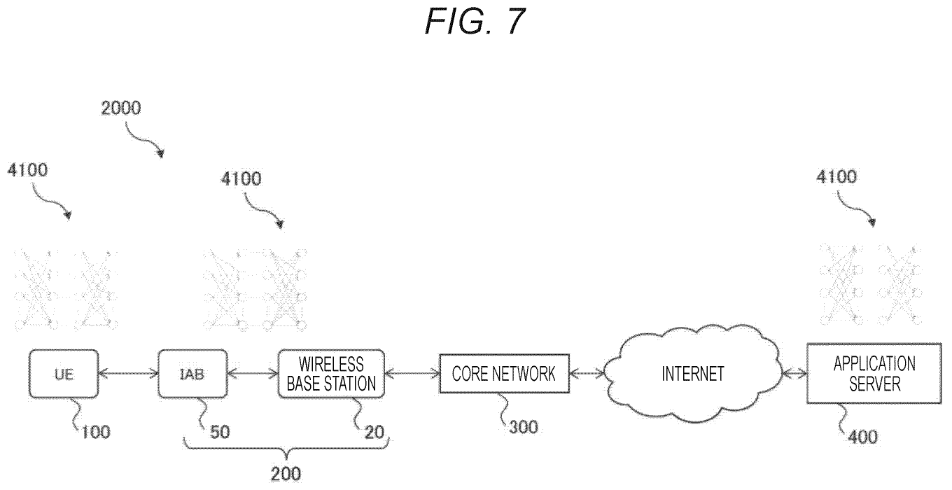

FIG. 7 illustrates an example of distributed processing of an NN model in a 5G network including IAB.

A 5G system 2000 of a second embodiment provides the function of the RAN 200 of the 5G system 1000 of the first embodiment by using IAB 50, in addition to a wireless base station 20.

In the embodiment of the present disclosure, a RAN 200 functions as a distributed network capable of distributed processing among multiple nodes by providing the function of the RAN 200 by using the IAB 50 in addition to the wireless base station 20.

For example, the wireless base station 20 as a donor node can utilize the IAB 50 as a one-hop or multi-hop relay node.

The distributed network may be a network other than a relay network using the IAB 50. For example, the distributed network may be repeater communication, a mesh-type network, or the like.

In the distributed network, terminals may directly communicate with each other. For example, the relay network may be configured by communication such as Bluetooth, UWB, WiFi, or 3GPP sidelink (PC5).

In the 5G system 2000, for example, arithmetic processing can be performed by treating the IAB 50 as an edge server that provides arithmetic processing capability in the 5G network.

In the embodiment of the present disclosure, an UPF 330 of a core network 300 also functions as a wireless communication unit capable of communicating with the wireless base station 20.

For example, UE 100 on which an AI application is operated can communicate with the core network 300 via the wireless base station 20 (first wireless base station).

For example, the UE 100 on which arithmetic processing other than the AI application is operated can communicate with the core network 300 via the wireless base station 20 (second wireless base station).

The UPF 330 may communicate with the wireless base station via the IAB 50, which is backhaul.

The wireless base station 20 can also indirectly communicate with the core network 300.

For example, the UE 100 can communicate with the core network 300 via the wireless base station 20 having different wireless base station 20. At this time, the wireless base station 20 that is not directly connected to the core network 300 can be treated as a wireless terminal.

The 5G system 2000 includes the UE 100, the IAB 50, the wireless base station 20, and the core network 300.

The 5G system 2000 is connected to an application server 400 via the Internet.

When the UE 100 determines use of an application that utilizes an NN model, the 5G system 2000 can distribute arithmetic processing of the NN model to the UE 100, the IAB 50, and the application server 400.

In the embodiment of the present disclosure, for example, the processing can be distributed as follows.

IAB-MT 501 of the IAB 50 constructs an interface Uu between with a DU 202 of the wireless base station 20.

A CU 201 of the wireless base station 20 and an IAB-DU 502 of the IAB 50 establish an interface F1 on this interface Uu.

In wireless backhaul, an IP layer is communicated on a backhaul adaptation protocol (BAP) sublayer, and a BAP PDU is communicated through backhaul (BH) RLC channel.

The IP layer can set multiple BH RLC channels for each BH link, for traffic priority and quality of service (QOS) processing. As a result, the IP layer can set different Qos processing in units of BH RLC channels, and the BAP sublayer can perform mapping processing of BH RLC channels and traffic for priority or QoS processing.

When the interface F1 is established, the CU 201 of the wireless base station 20 acquires QoS profile(s) for every BH RLC channel from the core network 300.

When a new BH RLC channel is established, the Qos profile(s) for every BH RLC channel is updated.

That is, in the embodiment of the present disclosure, the neural network model 4000 includes multiple sub-neural network models 4100, and can be split by the sub-neural network model 4100.

The above processing allows the CU 201 and the IAB-DU 502 of the IAB 50 to operate as a wireless base station for the UE 100, that is, the RAN 200 in FIG. 1.

When the UE 100 sends a PDU SESSION ESTABLISHMENT REQUEST message to an AMF 301 via the IAB 50, the 5G network executes PDU session establishment processing in accordance with processing illustrated in FIG. 6. In S613, the CU 201 of the wireless base station 20 acquires N2 SM information from an SMF 306 via the AMF 301. The N2 SM information includes PDU Session ID, QFI(s), QOS Profile(s), information regarding NN model splitting setting, and the like.

The splitting point of the NN model can be determined by any method.

For example, in a case where AI processing is performed in the 5G system 1000, cases are considered such as a case where processing is performed only by a DN 340, a case where processing is distributed by the IAB 50 and the DN 340, a case where processing is distributed by a terminal and the IAB 50, a case where processing is distributed by a terminal and the DN 340, a case where processing is distributed by a terminal, the IAB 50, and the DN 340, and a case where processing is performed only by the terminal.

For example, in the case where the processing is performed only by the DN 340, the AI processing is performed by the application server 400 connected via the Internet, in addition to the DN 340 included in the core network 300.

For example, in the case where processing is distributed by the IAB 50 and the DN 340, the AI processing is performed in a distributed manner by the application server 400 connected via the Internet, in addition to the IAB 50 included in the RAN 200 and the DN 340 included in the core network 300.

For example, in the case where processing is distributed by a terminal and the IAB 50, the AI processing is performed in a distributed manner by the application server 400 connected via the Internet, in addition to the UE 100 as the terminal and the IAB 50 included in the RAN 200.

For example, in the case where processing is distributed by a terminal and the DN 340, the AI processing is performed in a distributed manner by the application server 400 connected via the Internet, in addition to the UE 100 as the terminal and the DN 340 included in the core network 300.

For example, in the case where processing is distributed by a terminal, the IAB 50, and the DN 340, the AI processing is performed in a distributed manner in the application server 400 connected via the Internet, in addition to the UE 100 as the terminal, the IAB 50 included in the RAN 200, and the DN 340 included in the core network 300.

For example, in the case where the processing is performed only by the terminal, the AI processing is processed in a distributed manner by the application server 400 connected via the Internet, in addition to the UE 100 as the terminal.

First, the case where processing is distributed by the IAB 50 and the DN 340 will be described as the case of distributing the AI processing.

In the case where processing is distributed by the IAB 50 and the DN 340, the number of splits of the NN model is two.

Similarly to a case where the processing is performed in a distributed manner by the terminal and the network device, in a case where the application server 400 or the DN 340 determines in advance a splitting point with respect to the number of splits for every NN model, the NN model is specified according to the application used by the UE 100.

In this case, since the splitting point is determined in advance, the splitting point of the NN model corresponding to two as the number of splits is uniquely determined.

The CU 201 of the wireless base station 20 determines a splitting point of the NN model specified according to the application on the basis of the information regarding NN model splitting setting.

The CU 201 distributes arithmetic processing of the NN model to the IAB 50 and the DN 340 or the application server 400, in accordance with the determined splitting point.

The CU 201 of the wireless base station 20 may determine a splitting point on the basis of QFI, a QoS profile, a Qos profile(s) for every BH RLC channel, and profile information of the NN model.

For example, the CU 201 of the wireless base station 20 identifies the BH RLC channel mapped to the PDU Session ID, and refers to the QoS profile applied to this BH RLC channel.

For example, 5QI is applied to the QoS profile applied to the BH RLC channel.

The CU 201 of the wireless base station 20 identifies the 5QI applied to the BH RLC channel mapped to the PDU Session ID. The splitting point at the time of sending hidden layer data between the IAB 50 and the DN 340 (or the application server 400) is determined by a method of determining a splitting point on the basis of the profile information of the NN model in the case where processing is performed in a distributed manner by a terminal and a network device.

Next, a case where AI processing is distributed by the terminal and the IAB 50 will be described as the case of distributing the AI processing.

The IAB 50 is included in the RAN 200, and can be treated as a network device. In such a case, the case is considered to be equivalent to the case where processing is performed in a distributed manner by a terminal and a network device, and thus the description thereof is omitted.

Next, as the case of distributing the AI processing, the case where processing is distributed by a terminal and the DN 340 will be described.

In this case, two wireless sections, that is, between the UE 100 as the terminal and the IAB 50 (first wireless section) and between the IAB 50 and the wireless base station 20 (second wireless section), are used.

In this case, since the processing is distributed by the terminal and the DN 340, the number of splits of the NN model is two.

As a method of determining a splitting point in this case, there are a method of determining a splitting point in advance, the method of determining a splitting point on the basis of a data rate of Qos, and the method of determining a splitting point on the basis of a PER of QoS.

For example, in the method of determining a splitting point in advance, the application server 400 or the DN 340 determines a splitting point with respect to the number of splits in advance for every NN model.

In this method, the application server 400 or the DN 340 functions as the splitting unit.

The NN model is specified by determining the application used by the UE 100. In this case, since the splitting point is determined in advance, the splitting point of the NN model corresponding to two as the number of splits is uniquely determined.

The CU 201 of the wireless base station 20 determines a splitting point of the NN model specified according to the application on the basis of the information regarding NN model splitting setting. The CU 201 distributes arithmetic processing of the NN model to the UE 100 and the DN 340 or the application server 400 in accordance with the determined splitting point.

For example, in the method of determining a splitting point on the basis of a data rate of Qos, the CU 201 determines the splitting point on the basis of the QFI, the QoS profile, the QoS profile(s) for every BH RLC channel, and the profile information of the NN model.

In this method, the CU 201 functions as the splitting unit.

The CU 201 identifies, from the QoS profile corresponding to the QFI, a first 5QI to apply for sending hidden layer data between the terminal and the IAB 50.

The CU 201 identifies a second 5QI applied to the BH RLC channel mapped to the PDU Session ID.

The CU 201 uses the first 5QI and the second 5QI with a method similar to the method of determining a splitting point on the basis of a data rate of Qos in the case where processing is performed in a distributed manner by a terminal and a network device. The CU 201 estimates time required for sending on the basis of a data size of the hidden layer data and a GFBR or a UE-AMBR, and specifies a type of the NN model and a splitting point candidate that allow sending of the hidden layer data within preset time.

When estimating the time required for sending on the basis of the data size of the hidden layer data and the GFBR or the UE-AMBR, the CU 201 may take into account Packet Delay Budget of the specified first 5QI and second 5QI.

In the case where processing is distributed by a terminal and the DN 340, it is necessary to pay attention to a data rate mismatch between the first wireless section and the second wireless section.

For example, in a case where a data rate of the first wireless section is very high compared to a data rate of the second wireless section, hidden layer data transmitted with a low delay in the first wireless section cannot be transmitted at the same data rate in the second wireless section, and thus is buffered once in the IAB 50.

The buffered hidden layer data is transmitted to the DN 340 (or the application server 400) via the second wireless section.

That is, the CU 201 of the wireless base station 20 specifies the type of the NN model and the splitting point candidate on the basis of a buffer status of the IAB 50, the data rates of the first wireless section and the second wireless section, and the data size of the hidden layer data of each splitting point.

In a case where there are multiple types of the NN model and splitting point candidates, the splitting point may be determined further on the basis of processing capability of the UE 100.

For example, if the processing capability of the UE 100 is large, a type of the NN model and a splitting point with which the UE 100 can process more layers are determined.

For example, when the processing capability of the UE 100 is small, a type of the NN model and a splitting point for processing more layers on the application server 400 side are determined.

The processing capability of the UE 100 may be managed as UE radio capability, or may be provided from the UE 100 to the CU 201 as an information element (IE).

The CU 201 may determine a splitting point having the smallest data size, on the basis of information about a data size of the hidden layer data for every splitting point.

For example, if the processing capability of the UE 100 and the application server 400 is sufficient, the transmission delay in the wireless section becomes a bottleneck. The CU 201 can minimize the transmission delay by determining the splitting point having the smallest data size.

The CU 201 may use the number of nodes constituting a layer of the NN model, instead of the data size of the hidden layer data.

In a case where there are multiple types of the NN model and splitting point candidates, the CU 201 may determine a type of the NN model and a splitting point that allow improvement of reliability by performing scrambling or/and interleaving at the time of sending, within a range that allows sending within preset time.

In a case where there are multiple types of the NN model and splitting point candidates, the CU 201 may determine a type of the NN model and a splitting point that allow compression of the data size of the hidden layer data by performing data compression at the time of sending, within a range that allows sending within preset time.

The scrambling, the interleaving, or the data compression at the time of sending may be considered in a case where a type of the NN model and a splitting point candidate cannot be specified in data rate criteria of the GFBR or the UE-AMBR.

For example, the CU 201 may specify a type of the NN model and a splitting point candidate that allow improvement of reliability by performing scrambling or/and interleaving at the time of sending, or a type of the NN model and a splitting point candidate that allow sending of compressed hidden layer data, with the GFBR or the UE-AMBR within a range that allows sending within preset time.

For example, in the method of determining a splitting point on the basis of a PER of Qos, the CU 201 specifies a type of the NN model and a splitting point candidate on the basis of a lower limit value of the BLER for every splitting point of the NN model included in the profile information of the NN model.

In this method, the CU 201 functions as the splitting unit.

For example, the CU 201 can specify a type of the NN model and a splitting point candidate on the basis of packet error rate (PER) of the specified 5QI and the lower limit value of the BLER for every splitting point of the NN model.

The CU 201 may monitor communication quality between the UE 100 and the IAB 50 and between the IAB 50 and the wireless base station 20, for example, the SNR, and specify the type of the NN model and the splitting point candidate on the basis of the BLER corresponding to the communication quality.

The CU 201 may dynamically change the splitting point of the NN model on the basis of the dynamically changing communication quality and the lower limit value of the BLER for every splitting point of the NN model.

In a case where none of the lower limit values of the BLER for every splitting point of the NN model satisfies the PER of the current 5QI, the CU 201 may send a message requesting the AMF 301 to change the QFI, for example, PDU Session Modification Request.

The CU 201 may include a requested PER value or a requested QFI in the message.

Upon receiving the PDU Session Modification Request message from the CU 201, the AMF 301 sends a message (for example, Nsmf_PDUSession_UpdateSMContext Request) requesting the SMF 306 to change the QFI allocated to the current PDU session. As a result, the AMF 301 can request a change of QoS.

The AMF 301 may include PDU Session ID and the requested QFI in the message.

Upon receiving the message requesting the change of the QFI, the SMF 306 allocates a new QFI to the PDU session when permitting the requested QFI, and notifies the CU 201 in the wireless base station 20 of the updated QFI and QoS profile via the AMF 301, in response to the Nsmf_PDUSession_UpdateSMContext Response message.

The CU 201 specifies a type of the NN model and a splitting point candidate on the basis of a PER of the 5QI specified via the new QoS profile and the lower limit value of the BLER for every splitting point of the NN model.

Next, as the case of distributing the AI processing, the case where processing is distributed by a terminal, the IAB 50, and the DN 340 will be described.

In this case, two wireless sections, that is, between the UE 100 as the terminal and the IAB 50 (first wireless section) and between the IAB 50 and the wireless base station 20 (second wireless section), are used.

In this case, since the processing is distributed by the terminal, the IAB 50, and the DN 340 and is individually split into the first wireless section and the second wireless section, the number of splits of the NN model is three.

As a method of determining a splitting point in this case, there are a method of determining a splitting point in advance, the method of determining a splitting point on the basis of a data rate of Qos, and the method of determining a splitting point on the basis of a PER of QoS.

For example, in the method of determining a splitting point in advance, the application server 400 or the DN 340 determines a splitting point with respect to the number of splits in advance for every NN model.

In this method, the application server 400 or the DN 340 functions as the splitting unit.

The NN model is specified by determining the application used by the UE 100. In this case, since the splitting point is determined in advance, the splitting point of the NN model corresponding to three as the number of splits is uniquely determined.

The CU 201 determines a splitting point of the NN model specified according to the application on the basis of the information regarding NN model splitting setting. The CU 201 distributes arithmetic processing of the NN model to the UE 100, the IAB 50, and the DN 340, or the application server 400 in accordance with the determined splitting point.

For example, in the method of determining a splitting point on the basis of a data rate of Qos, the CU 201 determines the splitting point on the basis of the QFI, the QoS profile, the QoS profile(s) for every BH RLC channel, and the profile information of the NN model.

In this method, the CU 201 functions as the splitting unit.

The CU 201 identifies, from the QoS profile corresponding to the QFI, a first 5QI to apply for sending hidden layer data between the terminal and the IAB 50.

The CU 201 identifies a second 5QI applied to the BH RLC channel mapped to the PDU Session ID.

By using the first 5QI, the CU 201 estimates time required for sending on the basis of a data size of hidden layer data between the terminal and the IAB 50 and the GFBR or the UE-AMBR, and specifies a type of the NN model and a candidate of a first splitting point that allow sending of the hidden layer data within preset time, by using a method similar to the method of determining a splitting point on the basis of a data rate of QoS in the case where processing is performed in a distributed manner by a terminal and a network device.

Regarding the NN model of a subsequent stage that is split at the first splitting point, by using the second 5QI, the CU 201 estimates time required for sending on the basis of a data size of hidden layer data between the IAB 50 and the wireless base station 20 and the GFBR or the UE-AMBR, and specifies a candidate of a second splitting point that allow sending of the hidden layer data within preset time.

When estimating the time required for sending on the basis of the data size of the hidden layer data and the GFBR or the UE-AMBR, the CU 201 may take into account Packet Delay Budget of the specified first 5QI or second 5QI.

In a case where there are multiple types of the NN model and candidates of the first splitting point, the CU 201 may determine the first splitting point further on the basis of processing capability of the UE 100.

For example, if the processing capability of the UE 100 is large, a type of the NN model and a first splitting point with which the UE 100 can process more layers may be determined.

For example, when the processing capability of the UE 100 is small, a type of the NN model and a first splitting point for processing more layers on the IAB 50 and the application server 400 side may be determined.

The processing capability of the UE 100 may be managed as UE radio capability, or may be provided from the UE 100 to the CU 201 as an information element (IE).

In a case where there are multiple types of the NN model and candidates of the second splitting point, the CU 201 may determine the second splitting point further on the basis of processing capability of the IAB 50.

For example, if the processing capability of the IAB 50 is large, a type of the NN model and a second splitting point with which the IAB 50 can process more layers may be determined.

For example, when the processing capability of the IAB 50 is small, a type of the NN model and a second splitting point for processing more layers on the application server 400 side may be determined.

In a case where there are multiple types of the NN model and splitting point candidates, the CU 201 may determine a type of the NN model and a splitting point that allow improvement of reliability by performing scrambling or/and interleaving at the time of sending, within a range that allows sending within preset time.

In a case where there are multiple types of the NN model and splitting point candidates, the CU 201 may determine a type of the NN model and a splitting point that allow compression of the data size of the hidden layer data by performing data compression at the time of sending, within a range that allows sending within preset time.

The scrambling, the interleaving, or the data compression at the time of sending may be considered in a case where a type of the NN model and a splitting point candidate cannot be specified in data rate criteria of the GFBR or the UE-AMBR.

For example, the CU 201 may specify a type of the NN model and a splitting point candidate that allow improvement of reliability by performing scrambling or/and interleaving at the time of sending, or a type of the NN model and a splitting point candidate that allow sending of compressed hidden layer data, with the GFBR or the UE-AMBR within a range that allows sending within preset time.

For example, in the method of determining a splitting point on the basis of a PER of Qos, the CU 201 specifies a type of the NN model and candidates of the first splitting point and the second splitting point on the basis of a lower limit value of the BLER for every splitting point of the NN model included in the profile information of the NN model.

In this method, the CU 201 functions as the splitting unit.

For example, the CU 201 of the wireless base station 20 specifies a type of the NN model and candidates of the first splitting point and the second splitting point on the basis of a packet error rate (PER) of the specified first 5QI and second 5QI and the lower limit value of the BLER for every splitting point of the NN model.

The CU 201 of the wireless base station 20 monitors communication quality (for example, the SNR) between the terminal and the IAB 50 and between the IAB 50 and the wireless base station 20, and specifies a type of the NN model and candidates of the first splitting point and the second splitting point on the basis of the BLER corresponding to the communication quality.

The CU 201 of the wireless base station 20 may dynamically change the splitting point of the NN model on the basis of the dynamically changing communication quality and the lower limit value of the BLER for every splitting point of the NN model.

In a case where none of the lower limit values of the BLER for every splitting point of the NN model satisfies the PER of the current first 5QI or second 5QI, the CU 201 of the wireless base station 20 may send a message (for example, PDU Session Modification Request) requesting the AMF 301 to change a first QFI (QFI applied between the terminal and the IAB 50) or a second QFI (QFI applied between the IAB 50 and the wireless base station 20).

The CU 201 can include a requested PER value or a requested QFI in the message.

Upon receiving the PDU Session Modification Request message from the CU 201 of the wireless base station 20, the AMF 301 sends a message (for example, Nsmf_PDUSession_UpdateSMContext Request) requesting the SMF 306 to change the QFI allocated to the current PDU session.

The AMF 301 can include PDU Session ID and the requested QFI in this message.

Upon receiving the message requesting the change of the first QFI or the second QFI, the SMF 306 allocates a new QFI to the PDU session when permitting the requested QFI, and notifies the CU 201 in the wireless base station 20 of the updated first QFI or second QFI and QoS profile via the AMF 301, in response to the Nsmf_PDUSession_UpdateSMContext Response message.

The CU 201 of the wireless base station 20 specifies a type of the NN model and a splitting point candidate on the basis of a PER of the first 5QI or the second 5QI specified via the new QoS profile and the lower limit value of the BLER for every splitting point of the NN model.

In a case where the AI processing is distributed by a terminal, the IAB 50, and the DN 340 as the case of distributing the AI processing, it is important to determine a splitting point that maximizes the overall performance since multiple splitting points are determined.

For example, even if a data rate or a delay characteristic of one wireless section among multiple wireless sections satisfies the requirement, a data rate or a delay characteristic of another wireless section becomes a bottleneck in the overall performance, and a delay occurs in an arithmetic result of the NN model.

For example, in a case of determining a splitting point on the basis of a data rate of Qos, from among multiple NN models and splitting point candidates, the CU 201 of the wireless base station 20 determines a combination of the first splitting point and the second splitting point for minimizing a sum of a first period required for sending of the hidden layer data at the first splitting point and estimated from the first 5QI applied to the first wireless section and a second period required for sending of the hidden layer data at the second splitting point and estimated from the second 5QI applied to the second wireless section.

The CU 201 of the wireless base station 20 may take into account Packet Delay Budget of the specified first 5QI and second 5QI when estimating the time required for sending of the hidden layer data.

The CU 201 of the wireless base station 20 may determine a combination of the first splitting point and the second splitting point for minimizing a sum obtained by adding a third period to the first period and the second period, by estimating the third period necessary for the arithmetic operation of the NN model of a middle stage portion that is split by the first splitting point and the second splitting point in the function of the arithmetic processing included in the IAB, on the basis of information such as processing capability and a processing load of the function of the arithmetic processing included in the IAB.

The CU 201 of the wireless base station 20 may determine a combination of the first splitting point and the second splitting point for minimizing a sum obtained by adding a fourth period to the first period, the second period, and the third period, by further estimating the fourth period necessary for the arithmetic operation of the NN model of a preceding stage portion that is split at the first splitting point in the function of the arithmetic processing included in the terminal, on the basis of information such as processing capability and a processing load of the function of the arithmetic processing included in the terminal.

The CU 201 of the wireless base station 20 may determine a splitting point on the basis of information about a data size of the hidden layer data for every splitting point. For example, on the basis of the first 5QI and the second 5QI, in a case where a data rate of the first wireless section is larger than a data rate of the second wireless section, the CU 201 of the wireless base station 20 sets a splitting point having the smallest data size as the second splitting point for transmitting the hidden layer data via the second wireless section.

Among splitting point candidates of the preceding stage portion of the NN model split at the second splitting point, the CU 201 sets a splitting point having the smallest data size, as the first splitting point for transmitting the hidden layer data via the first wireless section.

Alternatively, in the CU 201, on the basis of the first 5QI and the second 5QI, in a case where a data rate of the second wireless section is larger than a data rate of the first wireless section, the CU 201 of the wireless base station 20 sets a splitting point having the smallest data size as the first splitting point for transmitting the hidden layer data via the first wireless section.

Among splitting point candidates of the subsequent stage portion of the NN model that is split at the first splitting point, the CU 201 sets a splitting point having the smallest data size, as the second splitting point for transmitting the hidden layer data via the second wireless section. For example, if processing capability of the UE 100, the IAB 50, and the application server is sufficient, the transmission delay in the wireless section becomes a bottleneck. Therefore, a transmission delay can be minimized by determining the splitting point having the smallest data size. The CU 201 may use the number of nodes constituting a layer of the NN model, instead of the data size of the hidden layer data.

In a case of determining a splitting point on the basis of a PER of Qos, by extracting a type of the NN model and candidates of the first splitting point and the second splitting point by using a method indicated by the method of determining a splitting point on the basis of a PER of the Qos, a combination of the first splitting point and the second splitting point may be determined from these candidates on the basis of the data rate of QoS described above.

Among the type of the NN model and candidates of the first splitting point and the second splitting point extracted on the basis of the PER of the Qos, it is possible to determine a combination of the first splitting point and the second splitting point for minimizing the sum of the first period required for sending of the hidden layer data at the first splitting point and the second period required for sending of the hidden layer data at the second splitting point.

On the basis of information such as processing capability and a processing load of the function of arithmetic processing included in the IAB, by estimating the third period necessary for the arithmetic operation of the NN model of the middle stage portion that is split by the first splitting point and the second splitting point in the function of the arithmetic processing included in the IAB and the fourth period necessary for the arithmetic operation of the NN model of the preceding stage portion that is split by the first splitting point in the function of the arithmetic processing included in the terminal, the CU 201 of the wireless base station 20 may determine a combination of the first splitting point and the second splitting point for minimizing a sum obtained by adding the third period and the fourth period to the first period and the second period. Furthermore, the CU 201 of the wireless base station 20 may take into account Packet Delay Budget of the specified first 5QI and second 5QI when estimating the time required for sending of the hidden layer data.

Furthermore, similarly to the case of the method of determining a splitting point on the basis of a data rate of Qos, it is necessary to pay attention to a data rate mismatch between the first wireless section and the second wireless section.

For example, in a case where a data rate of the first wireless section is extremely higher than a data rate of the second wireless section, the hidden layer data transmitted with a low delay in the first wireless section is transmitted through the second wireless section, after the arithmetic operation of the second-stage model of the NN model split into three by the IAB 50 is performed. Since the hidden layer data cannot be transmitted at the same data rate in the second wireless section unless the data size of the hidden layer data is reduced by the arithmetic operation of the second-stage model, the hidden layer data is once buffered by the IAB 50, and buffered hidden layer data is transmitted to the DN 340 (or the application server 400) via the second wireless section.

The CU 201 of the wireless base station 20 specifies a type of the NN model and a splitting point candidate on the basis of a buffer status of the IAB 50, the data rates of the first wireless section and the second wireless section, and the data size of the hidden layer data of each splitting point.

Although the embodiment has been described in which the CU 201 of the wireless base station 20 determines the splitting point on the basis of the QFI, the QoS profile, and the profile information of the NN model, the SMF 306 may determine the splitting point after the processing of S611 and give notification to the CU 201 of the wireless base station 20 via the AMF 301.

In a case where handover from a source IAB to a target IAB, which are the RAN 200, is executed according to mobility of the UE 100, the wireless base station 20 as an IAB-donor node may re-execute NN model splitting point determination processing (S614).

Even in a case where the IAB 50 as a parent node or the wireless base station 20 as the IAB-donor node is switched according to switching of a path of wireless backhaul, the CU 201 may cause the wireless base station 20 as the IAB-donor node to re-execute the splitting point determination processing (S614) of the NN model.

As described above, according to the embodiment of the present disclosure, nodes of the IAB 50 have a function of arithmetic processing. That is, the arithmetic processing of the NN model in the 5G network can be further distributed among the IAB nodes.

As a result, it is possible to prevent insufficient processing capability that causes a delay of the arithmetic processing.

Furthermore, the effects of the present disclosure described in the present specification are merely an example, and other effects may be achieved.

Note that the present invention is not limited to the embodiments described above as it is, and can be embodied by modifying the components without departing from the gist thereof in the implementation stage. Furthermore, various inventions can be formed by appropriately combining the plurality of components disclosed in the embodiments described above. For example, some components may be deleted from all the components illustrated in the embodiments. Moreover, the components of different embodiments may be appropriately combined.

Note that the present disclosure can also have the following configurations.

### Item 1

A wireless base station capable of communicating with a first communication device and a second communication device, the wireless base station including:
a splitting unit configured to acquire first profile information corresponding to one or more neural network models, and determine a splitting point for split of multiple layers constituting the neural network model on the basis of the first profile information; and
a control unit configured to set, in the first communication device, arithmetic processing of a first neural network model generated by splitting the neural network model at the splitting point, and set, in the second communication device or the wireless base station, arithmetic processing of a second neural network model generated by splitting the neural network model at the splitting point.

### Item 2

The wireless base station according to item 1, in which
the first communication device is a wireless terminal, and
the second communication device is a wireless terminal, another wireless base station, a core network, or a server connected via the core network.

### Item 3

The wireless base station according to item 1 or 2, in which
the first profile information includes the splitting point determined in advance.

### Item 4

The wireless base station according to any one of items 1 to 3, in which
the first profile information includes a data size of hidden layer data for each the splitting point of the neural network model.

### Item 5

The wireless base station according to any one of items 1 to 4, in which
the first profile information includes a relationship between an error rate at any of the splitting point and inference accuracy of an output value output by the neural network model.

### Item 6

The wireless base station according to any one of items 1 to 5, in which
the first profile information includes a lower limit value of an error rate of each the splitting point, the error rate satisfying a threshold of inference accuracy of the neural network model.

### Item 7

The wireless base station according to any one of items 4 to 6, in which
the splitting unit acquires second profile information regarding quality of service (QOS) that is an order and priority of communication between with the first communication device, and calculates a characteristic at a time of sending hidden layer data on the basis of a guaranteed flow bit rate (GFBR) or an aggregate maximum bit rate (AMBR) whose notification is given via the second profile information and on the basis of the data size of the hidden layer data that is split at the splitting point, the data size being included in the first profile information, and the splitting unit determines the splitting point on the basis of the characteristic at a time of sending the hidden layer data.

### Item 8

The wireless base station according to item 7, in which
the second profile information includes an allowable delay in the characteristic, and
the splitting unit calculates required time for sending the data size of the hidden layer data with the GFBR or the AMBR, and the splitting unit determines the splitting point with which the required time satisfies the allowable delay.

### Item 9

The wireless base station according to item 8, in which
in a case where there is no splitting point with which the required time satisfies the allowable delay, a change of QoS set for the communication is requested.

### Item 10

The wireless base station according to any one of items 5 to 9, in which
the splitting unit specifies a lower limit value of an error rate of each the splitting point satisfying a threshold of inference accuracy of the neural network model on the basis of the relationship included in the first profile information, and the splitting unit determines the splitting point on the basis of the lower limit value of the error rate of each the splitting point.

### Item 11

The wireless base station according to any one of items 6 to 10, in which
the splitting unit acquires an error rate related to communication between with the first communication device, and the splitting unit determines the splitting point on the basis of the acquired error rate and a lower limit value of an error rate for each the splitting point included in the first profile information.

### Item 12

The wireless base station according to item 11, in which
in a case where the acquired error rate related to the communication does not satisfy any of a lower limit value of an error rate for each the splitting point, the splitting unit requests a change of QoS set for the communication.

### Item 13

The wireless base station according to any one of items 1 to 12, in which
the wireless base station communicates with the first communication device directly or via a distributed network capable of performing distributed processing among multiple nodes.

### Item 14

The wireless base station according to any one of items 1 to 13, in which
in the first communication device, first arithmetic processing is operated, the first arithmetic processing being processing based on processing related to artificial intelligence.

### Item 15

The wireless base station according to item 14, in which
the first arithmetic processing is processing based on augmented reality, automated driving, robot control, image recognition, or voice recognition.

### Item 16

The wireless base station according to any one of items 1 to 15, in which
the neural network model includes multiple sub-neural network models.

### Item 17

The wireless base station according to item 16, in which
the splitting point splits by the sub-neural network model.

### Item 18

A method for controlling a wireless base station capable of communicating with a first communication device and a second communication device, the method including:
acquiring first profile information corresponding to at least one or more neural network models, and determining a splitting point for split of multiple layers constituting the neural network model on the basis of the first profile information; and
setting, in the first communication device, arithmetic processing of a first neural network model generated by splitting the neural network model at the splitting point, and setting, in the second communication device, arithmetic processing of a second neural network model generated by splitting the neural network model at the splitting point.

### Item 19

The method for controlling the wireless base station according to item 18, further including:
acquiring information regarding processing capability of the first communication device; and
determining the splitting point on the basis of the first profile information and the information regarding the processing capability.

### Item 20

The method for controlling the wireless base station according to item 18, further including:
acquiring information regarding an arithmetic load of the first communication device; and
determining the splitting point on the basis of the first profile information and the information regarding the arithmetic load.

### Item 21

The method for controlling the wireless base station according to item 18, further including:
acquiring information regarding a remaining battery level of the first communication device; and
determining the splitting point on the basis of the first profile information and the information regarding the remaining battery level.

### Item 22

The method for controlling the wireless base station according to any one of items 19 to 21, in which
determining a threshold related to processing capability, an arithmetic load, or a remaining battery level in the first communication device; and
performing setting for causing the first communication device to report the processing capability, the arithmetic load, or the remaining battery level in accordance with a relationship between with the threshold.

### Item 23

A program for causing a computer capable of communicating with a first communication device and a second communication device to execute:
a splitting step of acquiring first profile information corresponding to one or more neural network models, and determining a splitting point for split of multiple layers constituting the neural network model on the basis of the first profile information; and
a control step of setting, in the first wireless terminal, arithmetic processing of a first neural network model generated by splitting the neural network model at the splitting point, and setting, in the second wireless terminal, arithmetic processing of a second neural network model generated by splitting the neural network model at the splitting point.

### Item 24

A communication control device including:
a communication unit configured to communicate with a first wireless base station and a second wireless base station;
a splitting unit configured to acquire first profile information corresponding to at least one or more neural network models, and determine a splitting point for split of multiple layers constituting the neural network model on the basis of the first profile information; and
a control unit configured to set, in the first wireless base station, arithmetic processing of a first neural network model generated by splitting the neural network model at the splitting point, and set, in the second wireless base station, arithmetic processing of a second neural network model generated by splitting the neural network model at the splitting point.

### Item 25

A method for controlling a communication control device, the method including:
communicating with a first wireless base station and a second wireless base station;
acquiring first profile information corresponding to at least one or more neural network models, and determining a splitting point for split of multiple layers constituting the neural network model on the basis of the first profile information; and
setting, in the first wireless base station, arithmetic processing of a first neural network model generated by splitting the neural network model at the splitting point, and setting, in the second wireless base station, arithmetic processing of a second neural network model generated by splitting the neural network model at the splitting point.

### Item 26

A program for causing a computer to execute:
a communication step of communicating with a first wireless base station and a second wireless base station;
a splitting step of acquiring first profile information corresponding to at least one or more neural network models, and determining a splitting point for split of multiple layers constituting the neural network model on the basis of the first profile information; and
a control step of setting, in the first wireless base station, arithmetic processing of a first neural network model generated by splitting the neural network model at the splitting point, and setting, in the second wireless base station, arithmetic processing of a second neural network model generated by splitting the neural network model at the splitting point.

### REFERENCE SIGNS LIST

1000, 2000 5G system
100 UE
200 RAN
300 Core network
301 AMF
302 NEF
303 NRF
304 NSSF
305 PCF
306 SMF
307 UDM
308 AF
309 AUSF
310 UCMF
330 UPF
340 DN
201, 2011, 2012 CU
202 DU
50 IAB
400 Application server
4000 Neural network model
4001 Input layer
4002 Hidden layer
4003 Output layer
4100 Sub-neural network model

1. A wireless base station capable of communicating with a first communication device and a second communication device, the wireless base station comprising:
a splitting unit configured to acquire first profile information corresponding to one or more neural network models, and determine a splitting point for split of multiple layers constituting the neural network model on a basis of the first profile information; and
a control unit configured to set, in the first communication device, arithmetic processing of a first neural network model generated by splitting the neural network model at the splitting point, and set, in the second communication device or the wireless base station, arithmetic processing of a second neural network model generated by splitting the neural network model at the splitting point.

2. The wireless base station according to claim 1, wherein
the first communication device is a wireless terminal, and
the second communication device is a wireless terminal, another wireless base station, a core network, or a server connected via the core network.

3. The wireless base station according to claim 1, wherein
the first profile information includes the splitting point determined in advance.

4. The wireless base station according to claim 1, wherein
the first profile information includes a data size of hidden layer data for each the splitting point of the neural network model.

5. The wireless base station according to claim 1, wherein
the first profile information includes a relationship between an error rate at any of the splitting point and inference accuracy of an output value output by the neural network model.

6. The wireless base station according to claim 1, wherein
the first profile information includes a lower limit value of an error rate of each the splitting point, the error rate satisfying a threshold of inference accuracy of the neural network model.

7. The wireless base station according to claim 4, wherein
the splitting unit acquires second profile information regarding quality of service (QOS) that is an order and priority of communication between with the first communication device, and calculates a characteristic at a time of sending hidden layer data on a basis of a guaranteed flow bit rate (GFBR) or an aggregate maximum bit rate (AMBR) whose notification is given via the second profile information and on a basis of the data size of the hidden layer data that is split at the splitting point, the data size being included in the first profile information, and the splitting unit determines the splitting point on a basis of the characteristic at a time of sending the hidden layer data.

8. The wireless base station according to claim 7, wherein
the second profile information includes an allowable delay in the characteristic, and
the splitting unit calculates required time for sending the data size of the hidden layer data with the GFBR or the AMBR, and the splitting unit determines the splitting point with which the required time satisfies the allowable delay.

9. The wireless base station according to claim 8, wherein
in a case where there is no splitting point with which the required time satisfies the allowable delay, a change of QoS set for the communication is requested.

10. The wireless base station according to claim 5, wherein
the splitting unit specifies a lower limit value of an error rate of each the splitting point satisfying a threshold of inference accuracy of the neural network model on a basis of the relationship included in the first profile information, and the splitting unit determines the splitting point on a basis of the lower limit value of the error rate of each the splitting point.

11. The wireless base station according to claim 6, wherein
the splitting unit acquires an error rate related to communication between with the first communication device, and the splitting unit determines the splitting point on a basis of the acquired BLER and a lower limit value of an error rate for each the splitting point included in the first profile information.

12. The wireless base station according to claim 11, wherein
in a case where the acquired error rate related to the communication does not satisfy any of a lower limit value of an error rate for each the splitting point, the splitting unit requests a change of QOS set for the communication.

13. The wireless base station according to claim 1, wherein
the wireless base station communicates with the first communication device directly or via a distributed network capable of performing distributed processing among multiple nodes.

14. The wireless base station according to claim 1, wherein
in the first communication device, first arithmetic processing is operated, the first arithmetic processing being processing based on processing related to artificial intelligence.

15. The wireless base station according to claim 14, wherein
the first arithmetic processing is processing based on augmented reality, automated driving, robot control, image recognition, or voice recognition.

16. The wireless base station according to claim 1, wherein
the neural network model includes multiple sub-neural network models.

17. The wireless base station according to claim 16, wherein
the splitting point splits by the sub-neural network model.

18. A method for controlling a wireless base station capable of communicating with a first communication device and a second communication device, the method comprising:
acquiring first profile information corresponding to one or more neural network models, and determining a splitting point for split of multiple layers constituting the neural network model on a basis of the first profile information; and
setting, in the first communication device, arithmetic processing of a first neural network model generated by splitting the neural network model at the splitting point, and setting, in the second communication device or the wireless base station, arithmetic processing of a second neural network model generated by splitting the neural network model at the splitting point.

19. The method for controlling the wireless base station according to claim 18, further comprising:
acquiring information regarding processing capability of the first communication device; and
determining the splitting point on a basis of the first profile information and the information regarding the processing capability.

20. The method for controlling the wireless base station according to claim 18, further comprising:
acquiring information regarding an arithmetic load of the first communication device; and
determining the splitting point on a basis of the first profile information and the information regarding the arithmetic load.

21. The method for controlling the wireless base station according to claim 18, further comprising:
acquiring information regarding a remaining battery level of the first communication device; and
determining the splitting point on a basis of the first profile information and the information regarding the remaining battery level.

22. The method for controlling the wireless base station according to claim 19, further comprising:
determining a threshold related to processing capability, an arithmetic load, or a remaining battery level in the first communication device; and
performing setting for causing the first communication device to report the processing capability, the arithmetic load, or the remaining battery level in accordance with a relationship between with the threshold.

23. A program for causing a computer capable of communicating with a first communication device and a second communication device to execute:
a splitting step of acquiring first profile information corresponding to one or more neural network models, and determining a splitting point for split of multiple layers constituting the neural network model on a basis of the first profile information; and
a control step of setting, in the first communication device, arithmetic processing of a first neural network model generated by splitting the neural network model at the splitting point, and setting, in the second communication device, arithmetic processing of a second neural network model generated by splitting the neural network model at the splitting point.

24. A communication control device comprising:
a communication unit configured to communicate with a first wireless base station and a second wireless base station;
a splitting unit configured to acquire first profile information corresponding to one or more neural network models, and determine a splitting point for split of multiple layers constituting the neural network model on a basis of the first profile information; and
a control unit configured to set, in the first wireless base station, arithmetic processing of a first neural network model generated by splitting the neural network model at the splitting point, and set, in the second wireless base station, arithmetic processing of a second neural network model generated by splitting the neural network model at the splitting point.

25. A method for controlling a communication control device, the method comprising:
communicating with a first wireless base station and a second wireless base station;
acquiring first profile information corresponding to one or more neural network models, and determining a splitting point for split of multiple layers constituting the neural network model on a basis of the first profile information; and
setting, in the first wireless base station, arithmetic processing of a first neural network model generated by splitting the neural network model at the splitting point, and setting, in the second wireless base station, arithmetic processing of a second neural network model generated by splitting the neural network model at the splitting point.

26. A program for causing a computer to execute:
a communication step of communicating with a first wireless base station and a second wireless base station;
a splitting step of acquiring first profile information corresponding to one or more neural network models, and determining a splitting point for split of multiple layers constituting the neural network model on a basis of the first profile information; and
a control step of setting, in the first wireless base station, arithmetic processing of a first neural network model generated by splitting the neural network model at the splitting point, and setting, in the second wireless base station, arithmetic processing of a second neural network model generated by splitting the neural network model at the splitting point.
